(19) United States
(12) Patent Application Publication
(10) Pub. No.: US 2007/0069056 A1
(43) Pub. Date: Mar. 29, 2007

(54) PLANT TRIMMER

(76) Inventors: LEVI SHOUSE, San Diego, CA (US); WILLIAM RECK, Santee, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/456,023

(22) Filed: Jul. 6, 2006

Related U.S. Application Data
(60) Provisional application No. 60/721,601, filed on Sep. 28, 2005.

(51) Int. Cl. B02C 18/18

(52) U.S. Cl. 241/277

(57) ABSTRACT

The present invention relates generally to a trimming machine used to cut flowers or other plant material into small sized fragments or to prune unwanted thorns or leaves off of plants and flowers. This machine trims flower petals into small pieces which can be used in potpourri or other displays. This machine enables the user to generate a greater volume of flower petals then the traditional method of hand trimming with a scissors. This machine can also trim the unwanted leaves, buds or thorns off plants and flowers.

### CROSS-REFERENCE TO RELATED APPLICATION

This application claims priority to Provisional Application No. 60/721,601, filed Sep. 28, 2005, which is hereby incorporated by reference.

### BACKGROUND

1. Field of the Invention

The present invention relates generally to a trimming machine used to cut flowers or other plant material into small sized fragments or to prune unwanted thorns or leaves off of plants and flowers.

2. Related Art

Weed whackers, power trimmers or other gardening cutters are well known in the art. Edger devices and other horticultural cutting apparatuses are disclosed in U.S. Pat. Nos. 5,490,371, 6,062,318 and 6,880,251. Apparatuses with cutting blades for making wood curls or wood chips for use in potpourri are also well known in the art see U.S. Pat. Nos. 5,762,122; 4,346,744; 4,685,497; and 4,298,044. However, these machines cannot be used for cutting large volumes of flowers and other plant material for use in potpourri, catnip or other decorative arrangements. Furthermore, these machines cannot be used to trim unwanted leaves, thorns or buds off of plants and flowers.

### SUMMARY

To solve these problems and others, the present invention involves a machine used for trimming flowers or other plant material. This machine trims flower petals into small pieces which can be used in potpourri or other displays. This machine enables the user to generate a greater volume of flower petals then the traditional method of hand trimming with a scissors. This machine can also trim the unwanted leaves, buds or thorns off plants and flowers. The present invention can be used to make catnip or prune flowers for use in floral displays. The flowers or other plant material are rolled on the machine to avoid the course stems being cut and incorporated into the final product or to preserve stems and buds of the plants and flowers. This machine reduces the labor needed to perform these tasks which are traditionally done by hand.

An embodiment of the present invention includes a cutting chamber which includes a cutting blade, two fan blades, a motor, and a motor housing. In a further embodiment a safety wire which functions with a brake release attached to the grate is also present. The cutting chamber is encircled by a cylindrical protective outer housing. Attached to the housing are a plug and a power switch which connect with wires inside the cutting chamber providing electrical power to the motor. The cutting chamber of this invention is covered by a grate and sits upon legs or a stand. A bag or other catching chamber is either attached or set below the cutting chamber. The motor inside the cutting chamber causes the cutting blade and fan blades to spin. The motion of the fan blades in conjunction with the flat cylindrical shape of the housing creates a downward suction.

The user rolls flowers or plant material on the grate, the spinning of the fan blades below the grate create a vacuum suction which pulls the petals, thorns and leaves of the plants into the cutting chamber. The sections of plant material which enter into the cutting chamber are trimmed by the cutting blade and are sucked down into the attached bag or catching chamber below. The height of the cutting blade can be set from 1/16 to ½ an inch distance from the grate, thus enabling the user to vary the size of the cut material or obtain a closer trim of the plant or flower.

The grate attaches to the top of the cutting chamber. The grate has a brake release which extends into the cutting chamber to connect with the safety wire. The blades in the cutting chamber will not rotate unless the grate is attached to the cutting chamber and the brake has made contact with the safety wire. If the grate is removed and the brake loses contact with the safety wire the blades will stop rotating. The grate can be easily removed for cleaning or to access the interior of the cutting chamber.

The legs or stand upon which the cutting chamber sits can be removed to allow for storage and shipping of the device. The catching chamber or bag can be removed for cleaning, replacement and to dump out the plant fragments which are created. The present invention is resistive to the environmental elements to avoid rust and corrosion.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a perspective view of an embodiment of the plant trimmer.

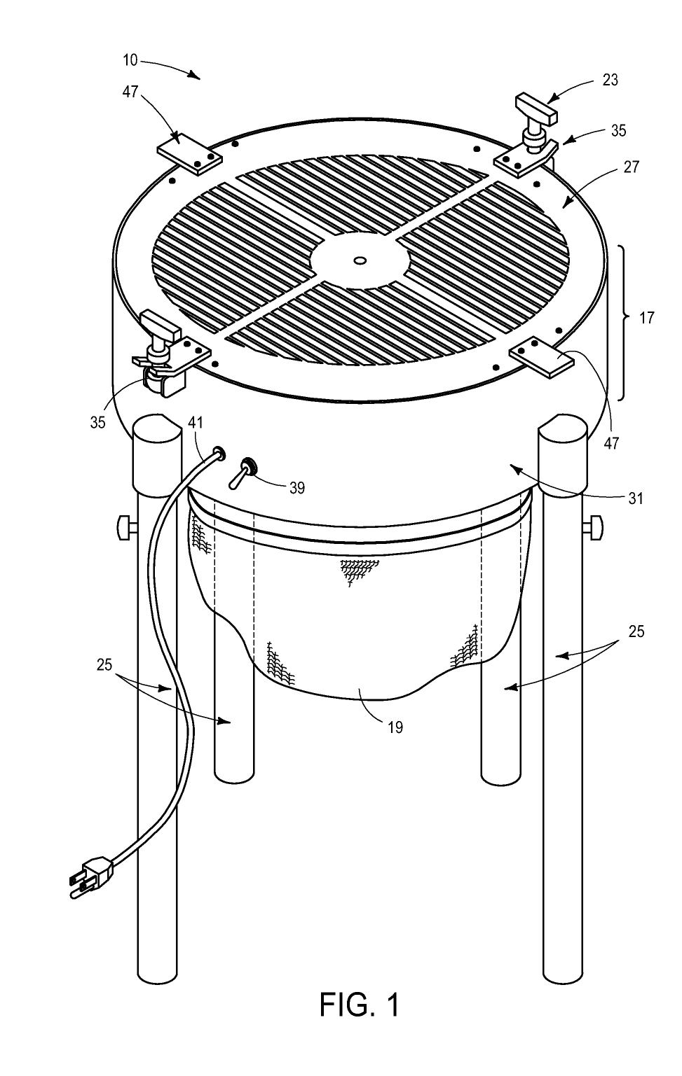

FIG. 2 is a top view of the plant trimmer illustrated in FIG. 1 looking down upon the grate.

FIG. 3 is a perspective view of one of the clamps which connects the grate to the cutting chamber of the plant trimmer illustrated in FIG. 1.

FIG. 4 is a prospective view of the plant trimmer illustrated in FIG. 1 with the grate lifted so that the blades are displayed.

FIG. 5 is a enlarged perspective view of the cutting blades connected to the motor of the plant trimmer displayed in FIG. 1

### DETAILED DESCRIPTION

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

The plant trimmer functions to trim the unwanted leaves, branches or thorns off plants and flowers. It can be used to make catnip or prune flowers for use in floral displays. The flowers or the plant material are rolled on the machine to avoid the coarse stems being cut and incorporated into the final product or to preserve the stems and buds for later use. A preferred embodiment of the present invention includes a cutting chamber which houses a cutting blade, two fan blades, a motor, a motor housing, and a safety wire which functions with the brake release to the attached grate. The machine is used by rolling the flowers or plant material on the top grate, the spinning of the fan blades below the grate create a vacuum of suction which pulls the petals, thorns and leaves of the plants into the cutting chamber. Suctionable plant material which enters the cutting chamber are trimmed by the cutting blade and are sucked down into the attached bag of catching chamber below. The catching chamber or bag can be removed for cleaning, replacement and to dump out the plant fragments which are created.

FIG. (“Fig.”) 1 is a perspective view of an embodiment of the plant trimmer (trimmer). The trimmer 10 is a self-contained apparatus which can sit upon the ground in variety of environments. In the embodiment shown the trimmer 10 includes a cutting chamber 17 that sits upon four legs 25. The height of each of the four legs can be adjusted in order to level the trimmer on uneven ground. A bag or a catching chamber 19 to collect the plant material hangs or sits below the cutting chamber 17 between the four legs or stand 25. A grate 27 sits on top of the cutting chamber 17 and is fastened by two hood latches 23 which are attached to the cutting chamber 17 and lock into two catches 35 attached to either side of the grate 27. Two handles 47 are attached to the grate 27 so that it can be easily removed without the user sticking his hands or fingers into the cutting chamber 17.

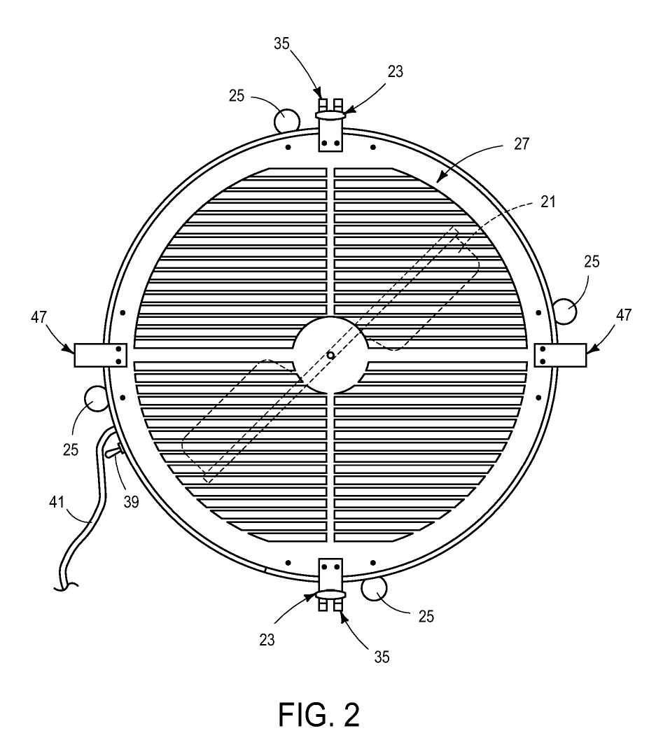

FIG. 2 is a top view of the trimmer. When looking down upon the trimmer, the blades 21 can be seen just below the surface of the grate. The height of the cutting blade can be set from 1/16 to ½ an inch distance from the grate. The setting of the blade enables the user to vary the size of the cut material or obtain a closer trim of the flowers or plants. The blades derive electricity from a power source. The trimmer connects via its cord 41 to the power source. The trimmer is turned on and off with a small trip switch 39. The grate is locked into place by the two knobs on either the end 23 which lock into the connection 35 at either side of the grate. The grate can be lifted off the trimmer by the handles 47 at either side of the grate.

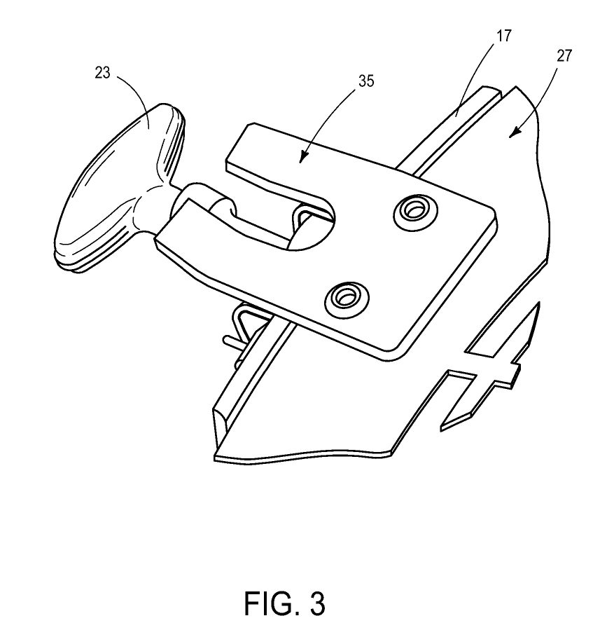

FIG. 3 is a perspective view of one of the clamps which connects the grate to the cutting chamber of the trimmer. The grate 27 sits on top of the cutting chamber and has two attached catches 35 which each contain a groove. Two hood latches 23 are attached to the housing 31 on opposite sides, they rotate on a vertical axis and lock into the attached catches on the grate 27. The grate 27 can be easily removed by rotating the hood latches 23 back down to a horizontal plane and removing the grate 27.

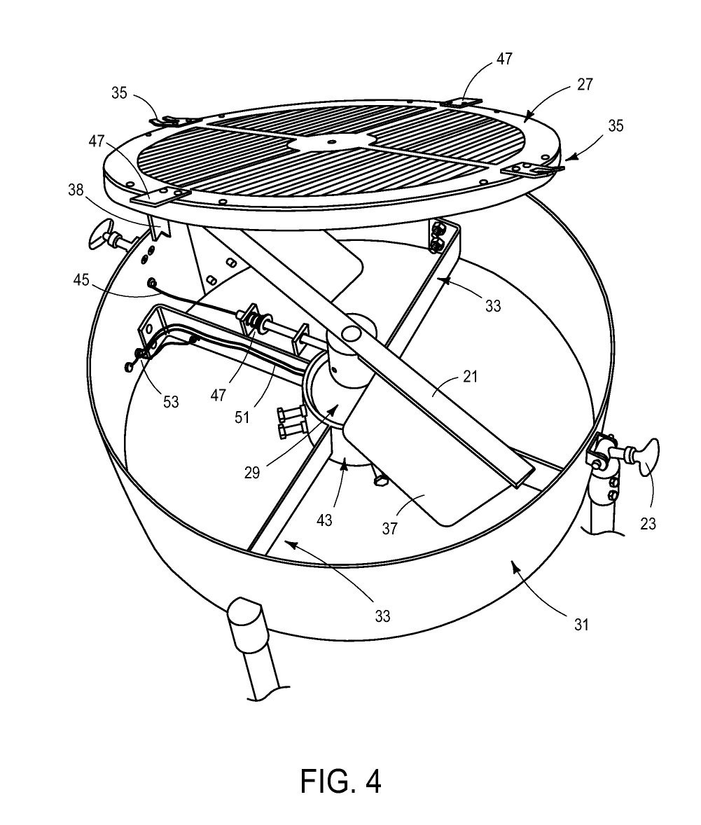

FIG. 4 is a prospective view of the plant trimmer with the grate lifted so that the blades are displayed. Referring to FIG. 4, the housing 31, the grate 27 and the brackets 33 of the embodiment shown can be manufactured from powder coated aluminum, injected molded plastic, carbon fiber or any other compatible metal. These materials protect the present invention from the elements so that it does not rust or corrode. The cutting blade 21 can be manufactured of steel or other metal.

In the embodiment shown, the cutting chamber contains a cutting blade 21 with cutting edges 37 on either side which is rotated on a single axis by a motor 29. Attached to either side of the cutting blade 21 are two fan blades 37 which rotate with the cutting blade 21 to create a vacuum. The motor 29 sits in a motor mount 43 which is held in place by four metal brackets 33 which attach to the housing 31 of the chamber. Power wires 51 run from a plug outside of the housing 31 through the cutting chamber 17 to the motor 29. A grounding wire 53 runs from the motor to the housing wall.

A further embodiment includes a safety wire 45 which connects to the motor 29 In this embodiment the cutting blade 21 will not spin unless the safety wire 45 is depressed by the brake release 38 on the grate 27. The brake release 38 is attached to the grate 27 when the grate 27 is placed on the cutting chamber 17 this brake release 38 makes contact with the safety wire 45 which allows the blades 37 to spin when the power is turned on. Thus in this embodiment, the trimmer will not work unless the grate is firmly attached to the cutting chamber.

In the embodiment shown the width of the openings on the grate 27 is between “¼” and “½”. This diameter allows plant and flower portions to pass through the grate but diminishes the ability for the entire plant or flower to be sucked into the machine. A power cord 41 (FIG. 2) extends from the housing to be plugged into any outlet; a power switch 39 (FIG. 2) is mounted on the exterior of the housing. A power wire 51 (FIG. 4) and ground wire 53 (FIG. 4) run from the power cord through the cutting chamber 17 to the motor 29.

One method of use of the trimmer involves rolling flowers or other plant material on top of the grate 27. The petals, leaves or buds are sucked through the grate by the vacuum suction generated by the fan blades 37; this material then extends into the cutting chamber 17 and is cut by the rotating blade 21 below. The speed of the rotation of the blades 37 and 21 is controlled by the motor 29 which in a the embodiment shown is at least 1200 RPM's or greater. The user may desire the cut flowers or other material to be used in potpourri or other decorative arrangements. In the alternative the user may need to trim plants for use in cat nip, trim thorns off of roses or other plants, trim leaves off of flowers or plants and a variety of additional trimming or cutting uses.

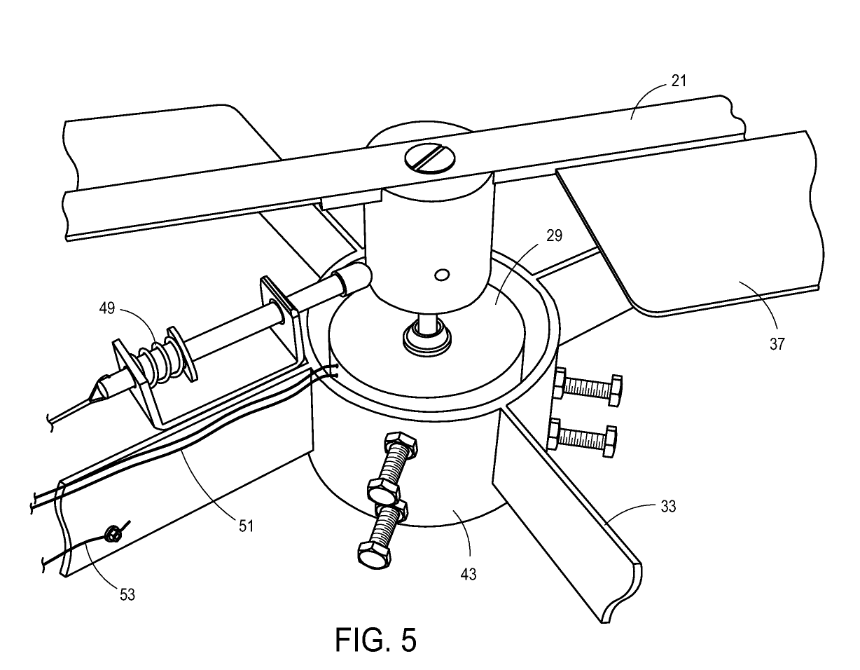

Referring specifically to FIG. 5, the motor 29 sits in a motor mount 43 and is held steady by bolts. The cutting blade 21 and fan blades 37 are attached to the top of the motor 29. The motor mount 43 is held in place by brackets 33 which are attached to the housing 31 (FIG. 4). These brackets are fastened by bolts or welded to the motor mount 43 at one end and to the housing 31 (FIG. 4) at the opposite end. The firm attachment of the motor 29 to the motor mount 43 and the motor mount 43 to the housing 31 (FIG. 4) reduces the vibration caused by the spinning of the blade 21 and stabilizes the Trimmer. The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A plant trimming apparatus comprising:
a cutting chamber encircled by a cylindrical protective housing including,
cutting blades,
two fan blades,
one or more electrical wires and
a motor housing enclosing a motor;
a grate covering and attached to the top of the cutting chamber;
a power cord connected to the electrical wires inside the cutting chamber providing electrical power to the motor;
one or more legs attached to the cutting chamber; and
a catching chamber below the cutting chamber.

2. The apparatus of claim 1, wherein the legs are a solid stand.

3. The apparatus of claim 1, wherein the cutting blades are adjustable below the grate to be moved closer or further away.

4. The apparatus of claim 1, wherein the legs are removable.

5. The apparatus of claim 1, wherein the catching chamber is removable.

6. The apparatus of claim 1 manufactured from a rust and corrosion resistant material.

7. The apparatus of claim 1, wherein the grate is attached to the cutting chamber with hood latches.

8. The apparatus of claim 1, wherein a break release is attached to the grate.

9. A machine for trimming plants comprising
a cutting chamber encircled by a cylindrical protective housing including,
one or more cutting blade,
one or more fan blade,
one or more electrical wires and
a motor housing enclosing a motor;
a grate with horizontal slits covering and attached to the top of the cutting chamber;
a power cord connected to the electrical wires inside the cutting chamber providing electrical power to the motor;
a stand attached to the cutting chamber; and
a catching chamber below the cutting chamber.

10. The machine of claim 9, wherein the cutting blades are adjustable below the grate to be moved closer or further away.

11. The machine of claim 9, wherein a safety wire and break release are attached to the grate.

12. The machine of claim 9, wherein the catching chamber is removable.

13. The machine of claim 9 manufactured from a rust and corrosion resistant material.

14. The machine of claim 9, wherein the grate is attached to the cutting chamber with hood latches.

15. A method of producing plant fragments comprising the steps of:
providing a cutting chamber covered by a grate containing cutting blades and fan blades;
rolling flowers or plant material on the grate enabling the leaves or flower material to extend into the cutting chamber;
creating a vacuum suction with the fan blades which pulls the leaves or flower material into the cutting chamber; and
rotating the cutting blades to cut the flowers and plant material into small fragments.

16. The method of claim 15 wherein the speed of the rotating cutting blades is adjustable.

17. The method of claim 15 wherein a catching chamber below the cutting chamber collects all of the plant fragments.

18. A method for trimming plants comprising the steps of:
providing a cutting chamber covered by a grate with slits in its surface containing
cutting blades,
fan blades,
a motor, and
electrical wires;
rolling the plants on the grate enabling the leaves or flower material to extend into the cutting chamber;
creating vacuum suction with the fan blades which pulls the leaves or flower material into the cutting chamber; and
rotating the cutting blades to cut the flowers, leaves or thorns off of the plants.

19. The method of claim 18 wherein the speed of the rotating cutting blades is adjustable.
